(19) United States
(12) Patent Application Publication
(10) Pub. No.: US 2026/0363225 A1
(43) Pub. Date: Nov. 19, 2026

(54) ANGLE LOCK FOR FISHING ROD HOLDERS

(71) Applicant: Shortbus Flashers, LLC, Tigard, OR (US)

(72) Inventor: Gerald T. GOULET, Tigard, OR (US)

(21) Appl. No.: 19/667,336

(22) Filed: May 4, 2026

Related U.S. Application Data
(60) Provisional application No. 63/805,014, filed on May 13, 2025.

(51) Int. Cl. A01K 97/10

(52) U.S. Cl. CPC A01K 97/10

(57) ABSTRACT

A fishing rod holder assembly with Hirth coupling teeth for precise, incremental angle adjustment is disclosed. The assembly includes a main body, a retainer assembly, and a locking mechanism with radial interlocking teeth that engage to provide secure, backlash-free positioning. The system allows for 4.5-degree adjustments per tooth and may be machined, ground, or injection-molded. The system prevents unintended movement, even under forces of 50 pounds, ensuring consistent rod positioning regardless of lead weight changes.

### RELATED APPLICATION

This application claims priority benefit of U.S. Provisional Patent Application No. 63/805,014, filed May 13, 2025, which is hereby incorporated by reference in its entirety.

### TECHNICAL FIELD

The present disclosure relates generally to angling equipment and, more specifically, to fishing rod holders designed for adjustable positioning and secure retention of a fishing rod.

### BACKGROUND INFORMATION

People have been fishing since the advent of written human history. As fishing techniques advanced, one method that emerged was angling, which involves using a rod and reel. This type of fishing is used in both commercial and sport fishing, employing lines to catch various types of fish. It applies to trolling, casting, and plunking, all of which involve a rod, reel, and line to catch fish.

As anyone who has fished knows, it sometimes takes a long time. As the common joke goes, that is why it is called fishing and not catching. While the experience is enjoyable, constantly holding fishing equipment can become heavy and cumbersome. When fishing for an extended period, it is useful to have a rod holder to keep the rod in place. Additionally, rod holders allow one person to use multiple rods without actively managing each one. These needs led to the development of rod holders, an example of which is shown in FIG. 1 as rod holder 100.

Holding the rod securely in a holder is vital. If a rod is simply laid down unsecured, it can obstruct movement, be dragged into the water, or accidentally fall in. Any of these outcomes could result in a lost rod or even injury.

One of the most important aspects of a rod holder is the angle at which the rod is held. The angle determines how the fishing rod interacts with the water, affecting both lure presentation and depth control. The rod tip’s position relative to the water surface provides a reference point for determining the effective fishing depth. Additionally, the weight of the lead sinker influences how the rod bends and shifts position above the water. This is particularly important when multiple rods are used on a boat, as varying lead weights can alter the fishing depth and rod alignment.

The action of the fishing rod also changes depending on the angle at which it is positioned relative to the water surface. A rod has what is called backbone or power, which refers to the way stiffness increases from the tip to the butt of the rod. This progressive increase in power gives the angler better control when fighting a fish. The action required for different lures dictates the appropriate rod power for various fishing techniques. Adjusting the rod angle shifts the point of maximum flex in the rod, affecting lure movement and performance.

To provide flexibility in rod angle adjustments, prior designs have used different approaches. Traditional rod holders often force a trade-off between secure locking and precise adjustability. Existing solutions rely on coarse-tooth locking mechanisms with limited adjustment angles or friction-based systems that can slip under load.

For example, rod holder 100 in FIG. 1 has a set of coarse internal gear teeth 102, including main body teeth 104 and retainer surface teeth 106, which interlock between a main body 108 and a retainer bearing post 110. By loosening an adjuster knob 112 (which secures a locking bolt, not shown), main body teeth 104 can be separated from retainer surface teeth 106, allowing main body 108 to be repositioned at a different pitch angle. Once the desired angle is set, adjuster knob 112 is tightened again. However, due to the large tooth size, each adjustment results in a relatively large change in rod angle. The longer the rod, the more noticeable the effect on the rod tip’s movement in relation to the angler.

Attempts have been made to increase the number of available adjustment angles. One prior design (see, e.g., FIG. 2 and FIG. 3) uses a disc (sometimes called an offset gear disc) with a fixed 7-degree offset between the coarse teeth on each side. This disc is placed between main body 108 and retainer bearing post 110, introducing the offset adjustment, as shown in FIG. 3. However, this approach does not provide additional fine adjustments beyond those available from the existing coarse internal gear teeth 102. As a result, precise tuning of the rod angle remains limited.

Another prior example, shown in FIG. 4, involves slip discs, which come in pairs. Each disc has coarse teeth on one side and a friction surface (e.g., rubber) on the other side. One disc interlocks with main body 108, while the other interlocks with retainer bearing post 110. Instead of relying on interlocking teeth for adjustment, the angle is held in place by friction between the smooth surfaces. While this approach allows for greater flexibility, friction-based locking mechanisms have limited effectiveness. If too much force is exerted—a common occurrence while fishing—the rod holder may slip, failing to maintain the desired angle. This can result in the rod being misaligned or, in the worst case, falling into the water.

### SUMMARY OF THE DISCLOSURE

The headings in this application are for reference purposes only and do not affect the meaning or interpretation of the present disclosure.

This disclosure describes a Hirth coupling system that provides both high positional accuracy and secure engagement. In some embodiments, the Hirth coupling system incorporates radial interlocking teeth allowing for 4.5-degree adjustability per tooth, offering four times the locking precision of conventional fixed-tooth designs while maintaining superior security compared to friction-based slip disc systems. These interlocking teeth, also referred to as Hirth coupling teeth, may be machined, ground, or molded depending on the material and manufacturing process. It is believed that these types of locking teeth have not been previously used in fishing rod holders (presumably due to concerns about strength) but the disclosed system successfully integrates them to provide both fine-tuned control and high durability.

In one embodiment, a fishing rod holder assembly includes a main body configured to receive and support a fishing rod, a retainer assembly coupled to the main body, and an angle locking system positioned between the main body and the retainer assembly. The angle locking system includes a first disc having a set of radially arranged interlocking teeth on a first mating face and a second disc having a complementary set of radially arranged interlocking teeth on a second mating face. The sets of interlocking teeth engage one another to provide incremental angle adjustment of the main body relative to the retainer assembly. In some embodiments, the sets of interlocking teeth include Hirth coupling teeth that provide positive indexed positioning of the main body relative to the retainer assembly.

In some embodiments, the interlocking teeth include tapered, triangular profiles that provide self-centering alignment during engagement of the first disc with the second disc. Each of the first disc and the second disc may include eighty Hirth coupling teeth, thereby providing approximately 4.5 degrees of angular adjustment per tooth. Each disc may further include coarse, outward-facing teeth on a face opposite the respective mating face, with the coarse outward-facing teeth configured to interlock with coarse internal gear teeth of the main body or the retainer assembly. In some embodiments, the coarse outward-facing teeth are compatible with existing rod holder equipment such that the first disc and the second disc provide a retrofit solution for conventional discs. Each disc may include a central aperture sized to receive a shaft of an adjuster knob, and each disc may include an embossed tooth count on a sidewall indicating a number of Hirth coupling teeth on the disc. In some embodiments, the angle locking system maintains engagement of the first disc with the second disc without slipping under at least 50 pounds of force applied to a tip of the fishing rod.

In another embodiment, a fishing rod holder angle-lock adapter system is provided for use with a fishing rod holder having a first set of coarse holder teeth and a second set of coarse holder teeth. The adapter system includes a first adapter disc and a second adapter disc. The first adapter disc includes a first outer face having first coarse adapter teeth configured to engage the first set of coarse holder teeth, and a first inner face having a first plurality of radially arranged face-locking teeth. The second adapter disc includes a second outer face having second coarse adapter teeth configured to engage the second set of coarse holder teeth, and a second inner face having a second plurality of radially arranged face-locking teeth complementary to the first plurality of radially arranged face-locking teeth. The first and second pluralities of radially arranged face-locking teeth engage one another at a plurality of indexed angular positions finer than angular positions provided by the first and second sets of coarse holder teeth. The first and second adapter discs are clampable between the first and second sets of coarse holder teeth to lock a fishing rod holder body at a selected angular position.

In some embodiments, each adapter disc includes a coarse-tooth interface on a first axial side and a fine-indexing face-serration interface on an opposite axial side. The first and second pluralities of radially arranged face-locking teeth may include Hirth-type teeth. In some embodiments, the radially arranged face-locking teeth provide an angular indexing increment of about 4.5 degrees. Each of the first and second adapter discs may include eighty radially arranged face-locking teeth.

In some embodiments, channels between adjacent ones of the radially arranged face-locking teeth are inclined relative to a face of the corresponding adapter disc. The channels may vary in depth along a radial direction of the corresponding adapter disc. In some embodiments, the channels are deeper adjacent radial ends of the radially arranged face-locking teeth and become shallower toward tapered portions of the radially arranged face-locking teeth. The channels may be inclined at an angle between about 5 degrees and about 10 degrees, and in some embodiments may be inclined at an angle of about 7.485 degrees.

In some embodiments, the first and second adapter discs are configured to replace an offset gear disc or a friction slip disc in an existing fishing rod holder. The first and second adapter discs may maintain engagement without slipping under at least 50 pounds of force applied to a tip of a fishing rod supported by the fishing rod holder. Each of the first and second adapter discs may include a central aperture having a draft angle configured to facilitate release of the adapter disc from a mold. In some embodiments, the draft angle is about 2 degrees. The first and second adapter discs may also be provided as a retrofit kit configured to replace an offset gear disc or friction slip disc of the fishing rod holder.

By allowing precise rod angle adjustments, this system enables a boat captain to maintain a consistent rod tip position relative to the water, regardless of lead weight changes. Unlike conventional systems that offer limited angle options (e.g., 10° or greater per step), the Hirth coupling provides fine-tuned, backlash-free positioning, ensuring reliable angle retention even under significant force.

Some or all of these improvements may be included in a single device. Additional aspects and advantages will be evident from the following detailed description of embodiments, which proceed with reference to the accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an exploded view of a rod holder, according to the prior art.

FIG. 2 is a pictorial view of several offset gears with outer locking teeth for the rod holder of FIG. 1, according to the prior art.

FIG. 3 is a pictorial view showing an offset gear of FIG. 2 deployed in the rod holder, according to the prior art.

FIG. 4 is a pictorial view showing slip discs deployed in the rod holder, according to the prior art.

FIG. 5 is a pictorial view showing Hirth coupling discs deployed in the rod holder, according to one embodiment.

FIG. 6 is a side elevation view of the Hirth coupling discs of FIG. 5.

FIG. 7 is an inward face elevation view of one of the Hirth coupling discs of FIG. 5.

FIG. 8 is an outward face elevation view of one of the Hirth coupling discs of FIG. 5.

FIG. 9 is a section view taken along lines 9—9 of FIG. 8.

FIG. 10 is a side elevation view of one of the Hirth coupling discs of FIG. 5.

FIGS. 11 and 12 are pictorial views showing a pair of Hirth coupling discs, according to another embodiment.

### DETAILED DESCRIPTION OF EMBODIMENTS

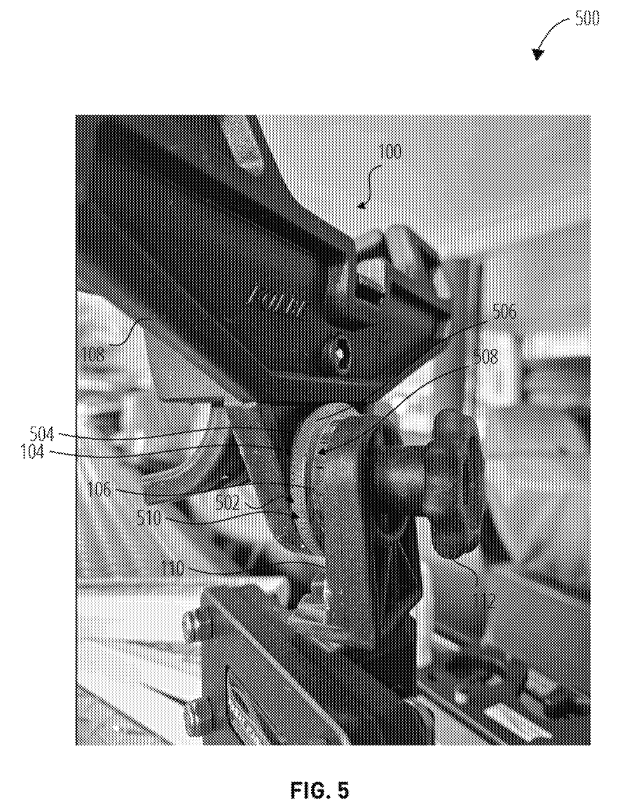

FIG. 5 shows a rod holder assembly 500 that includes a pair of Hirth coupling discs 502 (also referred to as adapter discs) integrated into rod holder 100, according to one embodiment. The term Hirth coupling refers to a type of mechanical connection that uses radial, interlocking serrations on the face of two mating components to securely transmit torque and provide precise angular alignment. This design is named after Albert Hirth.

More specifically, a Hirth coupling consists of a series of tapered, triangular teeth, machined or molded into the end face of a disc, gear, or shaft, allowing it to mate with an identical component to form a strong, backlash-free connection. This type of coupling is commonly found in high-precision applications such as machine tools, aerospace components, gas turbines, and indexing tables, where it can handle high torque loads with excellent positional accuracy.

While Hirth coupling is the industry-specific term, several other engineering terms describe similar features or concepts. Radial face serrations refer to the tooth pattern’s radial arrangement on the coupling face, while face spline coupling describes a splined interface that engages at the faces rather than along a shaft. Tapered face serrations emphasize the self-centering, angular tooth profile, and precision face-tooth coupling is another term that encompasses Hirth-type serrations as well as Curvic couplings. Another term of art is interlocking face teeth, which conveys the nature of the engaging surfaces. Although Hirth couplings are distinct in their design and function, they share some similarities with other face-tooth connections, such as Curvic couplings, which are used in high-speed machine tools and differ slightly in geometry and engagement mechanics.

In the example of FIG. 5, Hirth coupling discs 502 include a first Hirth coupling disc 504, engaged with main body teeth 104, and a second Hirth coupling disc 506, engaged with retainer surface teeth 106. Each Hirth coupling disc 502 features coarse, outward-facing teeth 508 (as previously described) for interlocking with rod holder 100, as well as precision-machined or molded Hirth serrations 510 (also referred to as Hirth coupling teeth) on its mating surface. Because coarse outward-facing teeth 508 are designed for existing equipment, the adapter discs convert a coarse-tooth rod holder adjustment interface into a fine-indexing face-serration interface. The outer faces of the adapter discs preserve compatibility with the existing coarse holder teeth, while the opposed inner faces provide a finer, positive-locking serrated interface between the discs. In this way, Hirth coupling discs 502 provide a retrofit solution for conventional discs.

FIG. 6 shows in greater detail that Hirth serrations 510 are radially arranged, forming an angular, sawtooth-like profile (FIG. 6) resembling small isosceles or equilateral triangles. Designed for positive, backlash-free engagement, Hirth serrations 510 interlock with the corresponding disc to ensure a secure, repeatable connection. Their fine pitch and uniform spacing enable high torque transmission and precise angular positioning. The tapered geometry of Hirth serrations 510 also allows for self-centering alignment during engagement, minimizing wear and ensuring reliable torque transmission.

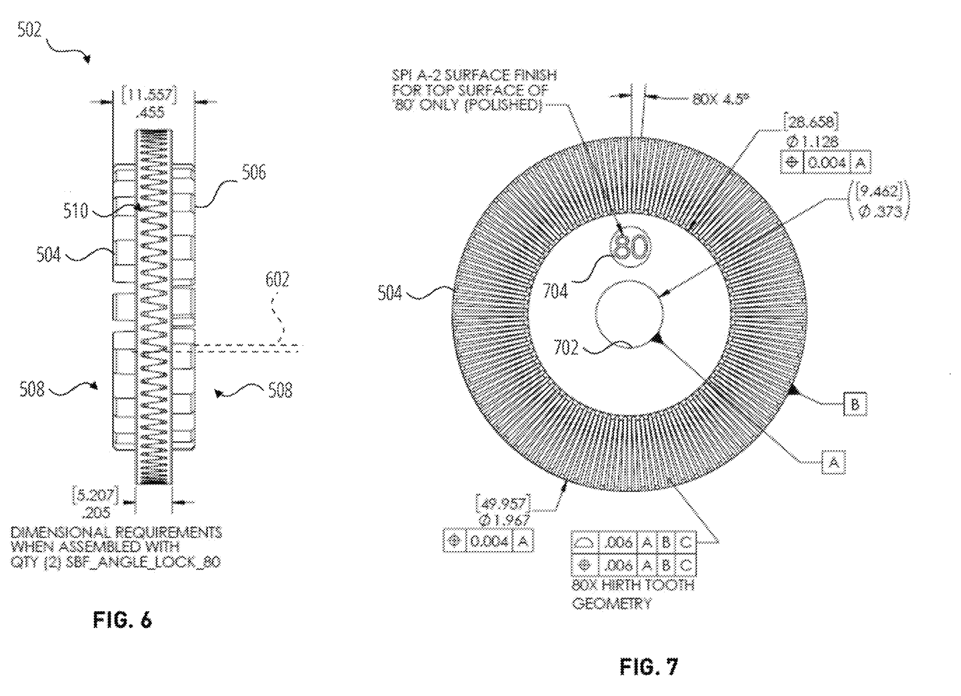

FIG. 6 also shows how Hirth coupling discs 502 are capable of being incrementally rotationally offset 602, i.e., angle adjusted, by one serration at a time. In this example, there are 80 teeth, which FIG. 7 shows equates to about 4.5° of adjustment per tooth. If additional teeth are added, every 16 teeth doubles the angle that can be controlled.

Fine angular adjustment of the rod holder is crucial in scenarios where small changes in rod tip position affect bait presentation, drift control, and hook-setting efficiency. For example, in trolling applications, small angle adjustments help optimize lure depth without modifying lead weight. Similarly, in drift fishing, precise angles ensure proper line control against varying water currents.

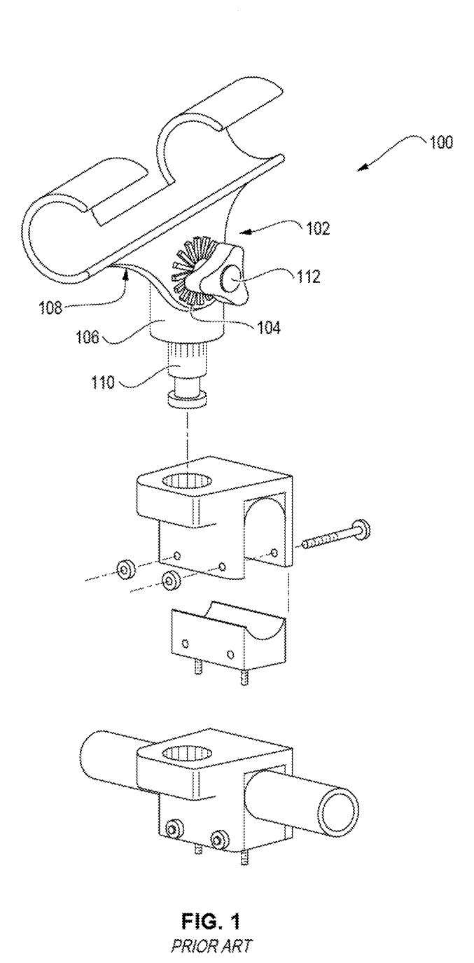

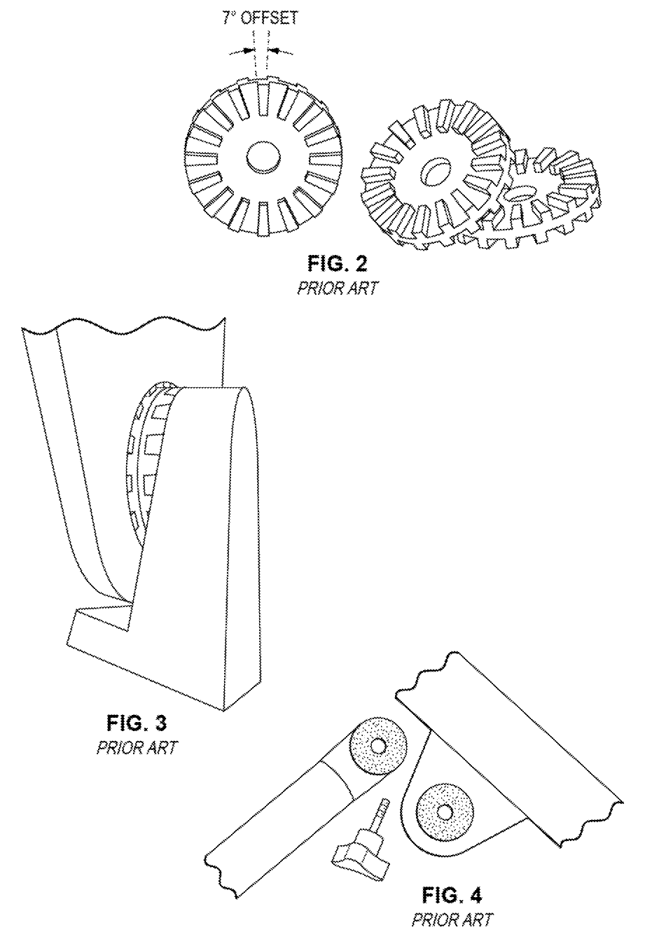

FIG. 7 also shows all Hirth serrations 510 of first Hirth coupling disc 504 (second Hirth coupling disc 506 is identical). It also shows a central aperture 702 sized to receive a shaft of adjuster knob 112 (FIG. 1). An embossed tooth count 704 is included on the sidewall of each Hirth coupling disc 502 so that matching discs can be used—reducing user error caused by using discs with different numbers of serrations.

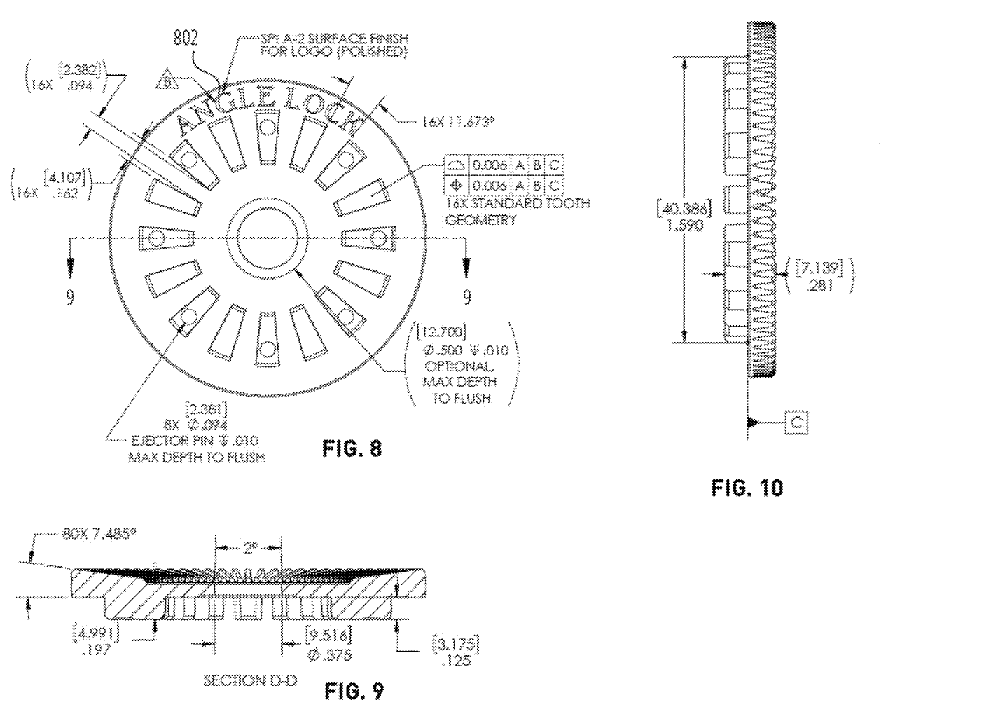

FIGS. 8-10 show additional views of first Hirth coupling disc 504. As shown in FIG. 8, first Hirth coupling disc 504 includes an embossed logo 802.

As shown in FIG. 9, Hirth serrations 510 are formed on an annular tooth-bearing region of each adapter disc. In the illustrated embodiment, the serration channels between adjacent teeth are inclined relative to the disc face, with the channel geometry corresponding to an angle of approximately 7.485°. This inclination provides greater channel depth and tooth mass toward the radial ends of the serrations while the channels become shallower toward the more tapered portions of the teeth. As a result, the serrations retain sufficient material at the radial ends for strength and positive engagement while maintaining the desired tapered tooth geometry across the annular tooth-bearing region.

FIG. 9 also identifies a 2° draft angle associated with the center opening of the adapter disc. The 2° draft angle facilitates release of the molded part from a mold and is not part of the tooth indexing pitch or the Hirth coupling engagement geometry. The tooth indexing pitch is instead defined by the number of serrations around the disc; for example, eighty serrations provide an angular pitch of approximately 4.5° between adjacent teeth.

FIG. 10 also shows the side elevation profile of the individual Hirth serrations 510, each having an approximately triangular cross-section with an included angle of approximately 16–24° at the tooth peak (approximately 8–12° per flank relative to the disc axis).

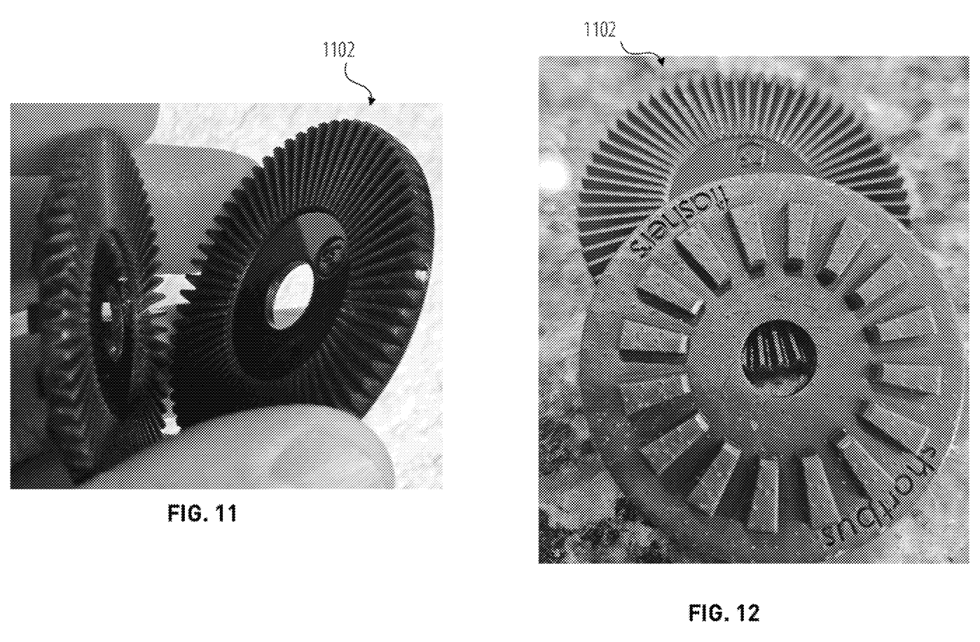

Finally, FIGS. 11 and 12 show another version of Hirth coupling discs 1102 that were 3D printed. In this version, Hirth coupling discs 1102 include 64 serrations.

A force test was conducted on Hirth coupling discs 1102, applying at least 50 pounds of force to the tip of a fishing rod secured in the rod holder. The test was terminated when the rod holder itself was nearing structural failure. During this test, Hirth coupling discs 1102 maintained engagement and did not slip. A production version, anticipated to be stronger due to injection molding, is expected to further improve durability.

Skilled persons will appreciate that many changes may be made to the details of the above-described embodiments without departing from the underlying principles of the invention. The scope of the present invention should, therefore, be determined only by claimed inventions and equivalents thereof.

What is claimed is:

1. A fishing rod holder assembly, comprising:
a main body configured to receive and support a fishing rod;
a retainer assembly coupled to the main body;
an angle locking system positioned between the main body and the retainer assembly, the angle locking system including:
a first disc having a set of radially arranged interlocking teeth on a first mating face; and
a second disc having a complementary set of radially arranged interlocking teeth on a second mating face,
wherein the sets of interlocking teeth engage to provide incremental angle adjustment of the main body relative to the retainer assembly,
wherein the sets of interlocking teeth comprise Hirth coupling teeth that provide positive indexed positioning of the main body relative to the retainer assembly.

2. The fishing rod holder assembly of claim 1, wherein the interlocking teeth comprise tapered, triangular profiles that provide self-centering alignment during engagement of the first disc with the second disc.

3. The fishing rod holder assembly of claim 1, wherein each of the first disc and the second disc includes 80 Hirth coupling teeth, providing approximately 4.5 degrees of angular adjustment per tooth.

4. The fishing rod holder assembly of claim 1, wherein each of the first disc and the second disc further includes coarse, outward-facing teeth on a face opposite the respective mating face, the coarse outward-facing teeth configured to interlock with coarse internal gear teeth of the main body or the retainer assembly.

5. The fishing rod holder assembly of claim 4, wherein the coarse outward-facing teeth are compatible with existing rod holder equipment such that the first disc and the second disc provide a retrofit solution for conventional discs.

6. The fishing rod holder assembly of claim 1, wherein each of the first disc and the second disc includes a central aperture sized to receive a shaft of an adjuster knob.

7. The fishing rod holder assembly of claim 1, wherein each of the first disc and the second disc includes an embossed tooth count on a sidewall thereof indicating a number of Hirth coupling teeth on the disc.

8. The fishing rod holder assembly of claim 1, wherein the angle locking system maintains engagement of the first disc with the second disc without slipping under at least 50 pounds of force applied to a tip of the fishing rod.

9. A fishing rod holder angle-lock adapter system for use with a fishing rod holder having a first set of coarse holder teeth and a second set of coarse holder teeth, the adapter system comprising:
a first adapter disc including a first outer face having first coarse adapter teeth configured to engage the first set of coarse holder teeth, and a first inner face having a first plurality of radially arranged face-locking teeth;
a second adapter disc including a second outer face having second coarse adapter teeth configured to engage the second set of coarse holder teeth, and a second inner face having a second plurality of radially arranged face-locking teeth complementary to the first plurality of radially arranged face-locking teeth;
wherein the first and second pluralities of radially arranged face-locking teeth are configured to engage one another at a plurality of indexed angular positions finer than angular positions provided by the first and second sets of coarse holder teeth; and
wherein the first and second adapter discs are clampable between the first and second sets of coarse holder teeth to lock a fishing rod holder body at a selected angular position.

10. The adapter system of claim 9, wherein each adapter disc includes a coarse-tooth interface on a first axial side and a fine-indexing face-serration interface on an opposite axial side.

11. The adapter system of claim 9, wherein the first and second pluralities of radially arranged face-locking teeth comprise Hirth-type teeth.

12. The adapter system of claim 9, wherein the first and second pluralities of radially arranged face-locking teeth provide an angular indexing increment of about 4.5 degrees.

13. The adapter system of claim 9, wherein each of the first and second adapter discs includes eighty radially arranged face-locking teeth.

14. The adapter system of claim 9, wherein channels between adjacent ones of the radially arranged face-locking teeth are inclined relative to a face of the corresponding adapter disc.

15. The adapter system of claim 14, wherein the channels vary in depth along a radial direction of the corresponding adapter disc.

16. The adapter system of claim 15, wherein the channels are deeper adjacent radial ends of the radially arranged face-locking teeth and become shallower toward tapered portions of the radially arranged face-locking teeth.

17. The adapter system of claim 16, wherein the channels are inclined at an angle between about 5 degrees and about 10 degrees.

18. The adapter system of claim 17, wherein the channels are inclined at an angle of about 7.485 degrees.

19. The adapter system of claim 9, wherein the first and second adapter discs are configured to replace an offset gear disc or a friction slip disc in an existing fishing rod holder.

20. The adapter system of claim 9, wherein the first and second adapter discs maintain engagement without slipping under at least 50 pounds of force applied to a tip of a fishing rod supported by the fishing rod holder.

21. The adapter system of claim 9, wherein each of the first and second adapter discs includes a central aperture having a draft angle configured to facilitate release of the adapter disc from a mold.

22. The adapter system of claim 21, wherein the draft angle is about 2 degrees.

23. The adapter system of claim 9, wherein the first and second adapter discs are provided as a retrofit kit configured to replace an offset gear disc or friction slip disc of the fishing rod holder.
